(19) United States
(12) Patent Application Publication
(10) Pub. No.: US 2026/0295585 A1
(43) Pub. Date: Oct. 1, 2026

(54) Microfluidic Closure Assemblies

(71) Applicant: Overture Life, Inc., New York, NY (US)

(72) Inventors: Lionel Matthys, Madrid (ES); Joana Alexandra Sales Fidalgo, Madrid (ES); Jesus Zambrano, Madrid (ES); Igor Tena, Madrid (ES)

(73) Assignee: Overture Life, Inc., New York, NY (US)

(21) Appl. No.: 19/578,661

(22) Filed: Mar. 25, 2026

Related U.S. Application Data
(60) Provisional application No. 63/778,196, filed on Mar. 26, 2025.

(51) Int. Cl. B01L 3/00

(52) U.S. Cl. CPC B01L 3/502723; B01L 2200/025; B01L 2200/0684; B01L 2200/0689; B01L 2300/042; B01L 2300/048; B01L 2300/123

(57) ABSTRACT

The present invention provides closure assemblies to reversibly seal microfluidic wells and methods of closing microfluidic wells using the closure assemblies. The closure assemblies maintain internal pressure within the microfluidic well by transitioning from an open configuration having a lid venting aperture above a gasket venting indent, to a closed configuration having the lid venting aperture above a gasket sealing protrusion.

### CROSS-REFERENCE

This application claims the benefit of U.S. Provisional Application No. 63/778,196 filed Mar. 26, 2025, which is incorporated herein by reference in its entirety.

### BACKGROUND OF INVENTION

Microfluidic devices are used in a wide range of research and clinical settings. In one clinical application, microfluidic devices can be used for in vitro fertilization (IVF) by providing a microfluidic well in which to prepare eggs or zygotes for cryopreservation and/or fertilization. Microfluidic devices for IVF applications include, e.g., U.S. Pat. No. 11,660,598.

It is desirable to maintain physical and visual access to the microfluidic well for delivery and retrieval of biological materials and to monitor the well contents during fluid delivery or removal.

It is also desirable to reversibly seal a microfluidic well to ensure sterility of the well contents. Especially when handling small samples (in terms of cell count and/or fluid volume), it is desirable to avoid contacting a cap with the contents of the microfluidic well and to maintain a consistent internal pressure within the microfluidic well during cap closure. Previous attempts to provide a well cap that can be applied and detached often suffer disadvantages in that they deliberately or inadvertently contact the well contents and/or increase pressure within the well during closure.

The present invention provides microfluidic closure assemblies and methods of microfluidic closure that maintain an internal pressure within the microfluidic well during closure.

### BRIEF SUMMARY OF THE INVENTION

In one embodiment, the present invention provides a closure assembly for a microfluidic well comprising a cap, a connector, and a gasket. The cap comprises a lid dimensioned to seal a microfluidic well, and a venting aperture disposed through the lid to provide gas exchange between the interior of the microfluidic well and the exterior of the microfluidic well. The connector comprises a connector aperture that provides access to the interior of the microfluidic well. The assembly comprises a joinder, e.g., screw threads or interlocking grooves and tabs, that mates the cap and connector. The gasket comprises a gasket aperture that provides access to the interior of the microfluidic well, a venting indent that provides gas exchange between the interior of the microfluidic well and the exterior of the microfluidic well when the venting aperture of the lid is positioned above the venting indent of the gasket to define an open configuration, and a sealing protrusion that obstructs gas exchange between the interior of the microfluidic well and the exterior of the microfluidic well when the venting aperture of the lid is positioned above the sealing protrusion of the gasket to define a closed configuration. The gasket is preferably compressible.

In one embodiment, the assembly further comprises a slope that increases in thickness approaching the venting aperture to increase the tension between the lid and the gasket as the assembly transitions from the open configuration to the closed configuration.

In one embodiment, the assembly further comprises a block to reduce the air headspace of the microfluidic well.

In one embodiment, the cap further comprises a venting incision.

In one embodiment, the connector further comprises a cap seating and/or a gasket seating. The connector can also include a recess to receive the lid.

The assembly transitions from an open configuration to a closed configuration. In one embodiment, closure is achieved by rotating the cap 90° or less. In some embodiments, closure comprises applying pressure along an upper surface of the cap. Preferably, the assembly maintains a constant interior pressure within the microfluidic well during closure.

In one embodiment, the assembly further comprises lateral projections.

In one embodiment, the assembly comprises an alignment means, e.g., seating pins, to align the components.

In one embodiment, one or more of the assembly components do not touch the sample in the well.

In one embodiment, the assembly further comprises a viewing window to provide visual access to the well.

In another embodiment, the present invention provides a microfluidic system comprising a closure assembly and a microfluidic layer comprising at least one microfluidic well connected to at least one microfluidic channel. The connector can be integral or separate from the microfluidic layer.

In one embodiment, the sample volume in the microfluidic well is 50 uL or less.

In another embodiment, the invention provides methods of closing a microfluidic well by placing the closure assembly over a microfluidic well in the open configuration, and transitioning the closure assembly from the open configuration to the closed configuration. In one embodiment, the transition is accomplished by rotating the cap 90° or less. In some embodiments, the transition further comprises applying pressure along an upper surface of the cap across a venting incision.

### BRIEF DESCRIPTION OF THE DRAWINGS

FIG. 1 shows an exploded view of an exemplary microfluidic system before cap placement.

FIG. 2 shows a top view of an exemplary microfluidic system in the closed configuration.

FIG. 3 shows an exploded view of a microfluidic device for use with a closure assembly.

FIG. 4 shows an exploded view of the closure assembly components.

FIGS. 5A-D show an exemplary cap. FIGS. 5A-B show top and bottom views, while FIGS. 5C-D show top and bottom perspective views.

FIGS. 6A-C show top and perspective views of exemplary gaskets.

FIGS. 7A-B show top and bottom views, respectively, of an exemplary connector.

FIGS. 8A-C show an exemplary closure assembly in open, transition, and closed configuration.

A summary of reference numbers and reference items is provided. Different views of same features are indicated by (a), (b), (c), etc. The designation of “first,” “second,” and “third,” is for labeling clarity only and does not require positioning or temporal order.

| Ref. No. | Ref. Item |
|---|---|
| 01 | Microfluidic system |
| 05 | Microfluidic device |
| 10 | Microfluidic layer |
| 12 | Microfluidic channel(s) |
| 15 | Microfluidic well |
| 20 | Bottom layer |
| 25 | Shield |
| 30 | Cover |
| 31/32 | First and second reservoir tops |
| 34 | Pressure inlet(s) sealing |
| 40 | Closure Assembly |
| 50 | Cap |
| 51 | Lid |
| 52 | Venting aperture |
| 53 | Slope |
| 54 | Block |
| 55 | Cap sidewall |
| 57a-c | Cap joinder, e.g., interlocking tabs |
| 58 | Venting incision |
| 60 | Lateral projection (reserved) |
| 61-63 | First, second, and third lateral projections |
| 70 | Gasket |
| 72 | Gasket aperture |
| 74 | Venting indent |
| 76 | Sealing protrusion |
| 78a, b | Alignment holes |
| 79a, b | Alignment pins |
| 80 | Connector |
| 82 | Connector aperture |
| 83 | Gasket seating |
| 84 | Cap seating |
| 85 | Connector sidewall |
| 87a-c | Connector joinder, e.g., interlocking grooves |
| 88 | Lid recess |

### DETAILED DESCRIPTION OF THE INVENTION

### I. Microfluidic Devices

The closure assemblies described herein are intended for use with microfluidic devices that include at least one microfluidic well.

Microfluidic System: In one embodiment, the invention provides a microfluidic system comprising: a) microfluidic well, and b) a closure assembly as described below. In another embodiment, the invention provides a microfluidic system comprising: a) a microfluidic device comprising a microfluidic well and one or more channels, and b) a closure assembly. In another embodiment, the invention provides a microfluidic system comprising: a) a microfluidic well, and b) a detachable closure assembly. In yet another embodiment, the invention provides a microfluidic system comprising: a) a microfluidic device comprising a microfluidic well and an integral connector, b) a detachable gasket, and c) a detachable cap.

Microfluidic Well: The microfluidic devices used with the present invention comprise at least one microfluidic well. The well can be any depression or chamber in a microfluidic layer that can contain a sample, but preferably the well includes one or more sidewalls and a floor. In one embodiment, the well is in fluid communication with at least one influx channel via an influx port and at least one efflux channel via an efflux port. The well can also include an upper perimeter defined by the top edge of the sidewall(s). Before the closure assembly is applied to the well, this well upper perimeter is typically exposed to the external environment, e.g., the ambient laboratory or clinical space.

The microfluidic well can have a maximum volume of about 300, 250, 200, 150, or 100 μL. In one embodiment, the microfluidic well has a maximum volume of 200 μL or less. As used herein, the “maximum well volume” is defined by the well floor, sidewall(s), and upper perimeter, and remains constant regardless of sample size. As used herein, the “sample volume” is the combined volume of the fluid contents and biological material contained within the well at any given point during operation. Accordingly, the maximum well volume is slightly larger than the sample volume. The sample volume can be equal to or less than 50, 40, 30, 20, or 10 μL. In one embodiment, the sample volume is 20 μL or less. The remainder of the maximum well volume not occupied by sample is occupied in typical use by ambient air, which forms a liquid-air interface with the sample.

It is an objective of the present invention that the air bubble between the well upper perimeter and the liquid-air interface exert little to no pressure on the sample during the application and closure of the well cap. When the well cap is applied and/or closed, it is desirable that no pressure is imposed on the air bubble. Pressure on the air bubble can transfer pressure to the sample and cause partial or total efflux of sample, e.g., fluid contents, from the well. The present closure assemblies have a novel venting system that maintains the internal pressure of the well while still permitting an airtight seal to the well upper perimeter.

It is also an objective of the present invention that the lid, or more preferably the entire cap, refrain from contacting the sample within the well. Maintaining physical separation of the cap from the sample ensures that the sample, especially biological material, will not be inadvertently lost or contaminated when using the cap. In other words, isolating the cap ensures that the biological material does not accidentally stick to the cap when the cap is removed; the biological material stays safely within the well.

Microfluidic channels: The microfluidic device can further comprise one or more microfluidic channels in fluid communication with the well to provide an influx or efflux of various fluids to or from the well. In a preferred embodiment, the microfluidic device includes at least one influx channel and at least one efflux channel, which distribute a fluid to and from, respectively, the microfluidic well. The channel(s) include a port at the junction of the channel and the well. Such channel ports provide fluid communication between the channel and well. The ports can be located on any location of the well wall. Preferably, at least one port is located at the bottom of the well wall.

Reservoirs: As one end of a microfluidic channel(s) can connect to the well, the opposite end of the channel(s) can connect to one or more reservoirs for storing fluids. For example, the device can include one or more storage reservoirs for holding fluids to be delivered to the well via one or more channel(s). Additionally or alternatively, the device can include a waste reservoir for holding fluids removed from the well via an efflux channel.

The term “sample” as used herein comprises a biological material component and a fluid component.

The fluid component can comprise a single solution (e.g, a buffer solution or a vitrification solution) or a mixture of solutions. The fluid component can be pre-loaded in the microfluidic well or it can be delivered to the well, e.g., from a reservoir through an influx channel and influx port to the well. The fluid contents in the well can be static or variable. Exemplary fluid components include, but are not limited to a revival solution, a vitrification solution, and a buffer solution. See, e.g., U.S. patent Ser. No. 11/660,598.

The biological material component can be a single cell, plurality of individual cells, a single mass of cells, a plurality of cell masses, or mixtures thereof. In a preferred embodiment, the biological material is a cumulus oocyte complex, an oocyte, zygote, blastocyte, or embryo. The biological material is preferably supplied via the open upper perimeter of the well by manual or automatic means before closing the well using the closure assembly. Additionally or alternatively, the biological material can also be retrieved from the well after detachment of the cap.

### II. Closure Assemblies

In one embodiment, the present invention provides closure assemblies that reversibly seal a microfluidic well. The closure assemblies comprise a) a cap, b) a connector, and a c) gasket.

a. Cap

The closure assemblies of the present invention comprise a cap. The cap comprises i) a lid dimensioned to seal a microfluidic well, and ii) a venting aperture through the lid. The cap can be fully detachable from both the remaining components of the closure assembly and/or the microfluidic device. Alternatively, the cap can be tethered to the connector and/or the microfluidic device.

i. Lid

The lid is dimensioned to be at least as large as the upper perimeter of the well such that when applied, the lid can create an air- and fluid-tight seal against the well upper perimeter. Both the lid and the well upper perimeter are preferably planar. In preferred embodiments, the lid seals the well by contacting a gasket disposed between the lid and the well. Accordingly, in one embodiment, the lid is dimensioned to be at least as large as a gasket aperture, the gasket aperture providing access to the interior of the microfluidic well.

Prior art caps and lids often feature a lid disposed at or near the topmost portion of the cap. The lid may sit atop the well or vessel perimeter, while a mechanical or frictional joinder component extends downward towards the well and mates along the interior or exterior surface of a well sidewall. In these contexts, the closure force, usually a downward and/or rotational force, is applied to the lid of the cap.

While it is possible to utilize a top-configured lid in the present invention, extra care, attention, or training would be required of the operator to ensure proper ventilation through the venting aperture and to prevent accidental occlusion of the venting aperture. Thus, in preferred embodiments, the lid is disposed in the bottom half of the cap, that is, in the portion of the cap that faces the well. In a preferred embodiment, the lid comprises the lower surface of the detachable cap. In other words, the lid is the base of the detachable cap. In this way, the cap can be closed onto the well without exerting direct force to the lid.

ii. Venting Aperture

The cap further comprises a venting aperture disposed through the lid to provide gas exchange between the interior of the microfluidic well and the exterior of the microfluidic well. The venting aperture can be of any shape (e.g., circular, oblong, lateral slit) and can extend perpendicularly or at an angle to the lid plane. The surface area of the venting aperture is preferably 1-5, 1-3, 2-4, or 3-5 mm². In one embodiment, the surface area of the venting aperture is about 3 mm². In one embodiment, the venting aperture is a circular hole with a diameter of less than 1 mm, preferably 0.25 mm to 0.75 mm, or about 0.6 mm.

Some prior art microfluidic caps include a venting aperture through which gases and/or fluids can be exchanged, deposited, or extracted from the microfluidic well while the cap is sealed to the well. In contrast, the venting aperture of the present invention provides gas exchange between the well and the exterior environment during placement in the open configuration and during transition from the open to the closed configuration. But in the closed configuration, the venting aperture is sealed against the gasket; fluid and gas exchange are obstructed in the closed configuration (although some incidental gas exchange may occur with imperfect manufacture or use).

In the present invention, the venting aperture can be positioned anywhere on the lid. For a circular lid, the venting aperture can be positioned at any point along a diameter or a chord of the lid. Notably, the venting aperture is not disposed directly above the well. Rather, the venting aperture is disposed to engage with a gasket venting indent and a gasket sealing protrusion which are disposed adjacent to, rather than directly above, the well. In one embodiment, the venting aperture is not located at the center of the lid. In another embodiment, the venting aperture is closer to the perimeter of the lid than to its center. This off-center or perimeter-adjacent placement of the venting aperture facilitates engagement with the gasket's venting indent and sealing protrusion. In another embodiment, the venting aperture is positioned at the center of the lid, but the microfluidic well is not aligned with the center of the lid when assembled.

In a preferred embodiment, the lid comprises a single venting aperture. The lid can comprise more than one venting aperture as long as each venting aperture corresponds with one or more venting indents and sealing protrusions in the gasket as described below.

The closure assembly can further comprise a sealing plug, preferably tethered to the cap, that can be inserted into the venting aperture in the closed configuration to provide an additional obstruction to gas exchange.

In one embodiment, the lid comprises a viewing window. The viewing window is transparent and aligns over the microfluidic well, preferably in both the open and closed configurations, to permit visual inspection of the well interior during operation. In one embodiment, the entire lid is made of a transparent material such that the entire lid is the viewing window. It will be understood that even if the entire lid is transparent, not all lid portions will provide visual well access. For example, the portion of the lid near the lid venting aperture will be obscured by the gasket sealing protrusion in the closed configuration. In another embodiment, a transparent portion of the lid is the viewing window. The viewing window can be, but need not be, the same shape or size as the lid or as the opening of the microfluidic well.

iii. Joinder

The cap further comprises a joinder that mates the cap to a connector. The joinder is preferably located along a sidewall of the cap, which aligns with a sidewall of the connector. In a preferred embodiment, the joinder is located on the exterior surface of the cap sidewall and the interior surface of the connector such that the cap is secured within the connector. The joinder can include any frictional, mechanical, or other means known to one of ordinary skill in the art. Preferably, the joinder is a mechanical joinder, e.g., screw threads or interlocking tabs, which can be disposed in either male/female arrangement. That is, the cap can comprise the male mechanical joinder component, and the connector can comprise the corresponding female mechanical joinder component or vice versa. In one embodiment, the mechanical joinder comprises screw threads. In another embodiment, the mechanical joinder comprises at least one interlocking groove and tab. In a preferred embodiment, the mechanical joinder comprises 3 interlocking grooves and tabs. In one embodiment, the closure assembly transitions from the open configuration to the closed configuration by rotating the cap relative to the connector by equal to or less than: 180°, 120°, 90°, 80°, 70°, 60°, 50°, 45°, or 40°.

iv. Venting Incision

The cap can further comprise a venting incision located in the top half of the cap. In a preferred embodiment, the venting incision is located in a cap sidewall and extends to an upper perimeter of the cap. The venting incision provides gas exchange between the interior of the microfluidic well and the exterior environment during the placement of the cap in the open configuration and the transition of the cap from the open to the closed configuration. The venting incision can be of any shape (e.g., semicircular, slit with constant width, wedge with varying width, etc.) and can extend parallel to or at an angle to the axis of the cap. The surface area of the venting incision is preferably 1-3, 1-2, or 1.5-2 mm². In a preferred embodiment, the venting aperture is a slit in the cap sidewall, parallel to the cap axis, with a width of 0.5-1 mm or about 0.7 mm and a length of about 2-3 or about 2.5 mm.

If a venting aperture is disposed through a lid and the lid is disposed in the top portion of the cap, it is possible to inadvertently occlude the venting aperture while applying downward and/or rotational force to the cap. If venting is partially or totally blocked during placement or closure, the closure forces may transfer pressure to the interior of the microfluidic well, which may in turn force the contents of the well to eject via one or more portals. Indeed, in previous attempts to create a microfluidic well closure assembly, the inventors have found that pressing a lid against the microfluidic well caused undesired ejection of well contents. Although occlusion can be avoided by meticulous user training and operation, a product designed to prevent venting occlusion will offer easier and more consistent results. The closure assemblies of the present invention permit venting of the well during placement and closure to reduce or prevent the increase pressure in the well interior.

In one way, the closure assemblies achieve the desired venting by positioning the lid and its venting aperture away from direct contact with closure forces. In another way, the closure assemblies can achieve the desired venting by additionally or alternatively providing a venting incision on the cap surface that is in direct contact with closure forces.

With a venting incision, even when closure force is applied to the cap, the venting incision provides gas exchange with the well interior. For example, even if an operator placed or pressed their finger along the entire upper surface of the cap, gas exchange to the exterior environment would be maintained even as the lid venting aperture would be indirectly obscured from the exterior environment.

In one embodiment, the closure assembly can include a corresponding seal to the venting incision that prevents gas exchange between the well and the environment in the closed configuration. For example, the venting incisions may align with a retractable or compressible seal in the sidewall of the connector that wholly or partially occludes the venting incision in the closed configuration. However, a venting incision seal is not required because once the lid venting aperture is sealed in the closed configuration, gaseous communication between the well and the venting incision is likewise obstructed. In other words, in certain embodiments, gas exchange afforded by the cap venting incision requires access through the lid venting aperture.

The cap can further comprise a lateral projection, as described below. In some embodiment, the venting incision is disposed opposite the lateral projection so that manipulation of the lateral projection will be less likely to obscure the venting incision.

b. Connector

The closure assemblies of the present invention further comprise a connector. The connector connects the cap to the microfluidic device, more particularly, at or near the upper perimeter the microfluidic well.

The connector comprises a joinder that mates the connector to the cap, as described above.

The connector can be a separately manufactured component, or it can be integral to the microfluidic device. In a preferred embodiment, the connector is integral to the microfluidic device, more particularly to a substrate comprising the microfluidic well.

The connector comprises a connector aperture that provides access to the interior of the microfluidic well. The operator can deposit, access, and/or extract contents from the microfluidic well through the connector aperture. In a preferred embodiment, the operator deposits and/or extracts biological material through the connector aperture to the well.

i. Seatings

The closure assembly can further comprise a gasket seating that supports a gasket. Particularly for integral connectors, the gasket seating can be a designated portion of the microfluidic device, e.g., the microfluidic substrate. For example, the portion of the microfluidic device surrounding the upper perimeter of the well can serve as the gasket seating. This portion of the device may also support the connector when the connector is a separate component. Alternatively, the connector can comprise a distinct platform to serve as the gasket seating. When the gasket seating is a distinct platform of the connector, the distinct platform can rest in whole or in part on the microfluidic device. Because the gasket should form an airtight seal against the microfluidic well when the cap is closed, it is desirable that the gasket seating and gasket be disposed directly against the upper surface of the microfluidic device.

The closure assembly can further comprise a cap seating that supports the cap. While the lid will be disposed in direct contact with the gasket, the weight or downward pressure of the cap can be supported in part by the gasket. The cap may also be supported by a cap seating, particularly along a portion or all of the perimeter of the cap. As with the gasket seating, the cap seating can be a portion of the microfluidic device (especially as with an integral connector), or it can be a distinct platform of a separate connector component.

The connector can further comprise a lid recess that accommodates the lid when the closure assembly is assembled. The lid recess is preferably a corresponding shape to the lid, with a modest clearance between the cap and lid recess. The clearance is preferably 0.1 mm to 0.3 mm to allow ease of placement and ease of transition between configurations. The lid recess is formed by one or more connector sidewalls. In preferred embodiments, these one or more connector sidewalls house the connector mechanical joinder that mates the connector to the cap.

ii. Lateral Projections

The connector can further comprise one or more lateral projections. The lateral projections can serve as insertion guides (to ensure that the cap is inserted in the correct orientation) and/or indicators of configuration status (to visually or mechanically indicate whether the cap is in an open, transition, or closed configuration). The lateral projections can also provide mechanical leverage, that is, they can provide a surface area against which the operator can push or pull against to manipulate the assembly, while the device as whole remains stationary. In a preferred embodiment, the connector comprises a first and second lateral projection, each of which can align with a third lateral projection on the cap. When the third (cap) lateral projection aligns with the first lateral projection, the closure assembly is in the open configuration. When the third (cap) lateral projection aligns with the second lateral projection, the closure assembly is in the closed configuration.

The lateral projections can be, but need not be, the same height as the cap and/or connector. The lateral projections can be any shape, for example, rod- or paddle-shaped. The lateral projections can be, but need not be the same shape or dimensions as one another. In one embodiment, the closure assembly comprises three paddle-shaped lateral projections. A “paddle-shaped” projection has a length and height that are larger than its width.

Alignment of lateral projections can be visual, vertical, or other alignment. Preferably, alignment of lateral projections comprises direct contact (abutment) of the lateral projections.

Additionally or alternatively, the closure assembly can include other visual or mechanical alignment means as described below.

c. Gasket

The closure assemblies of the present invention further comprise a gasket. The gasket can be any component that seals the cap to the microfluidic well. The gasket can be a separable component, similar to an O-ring or sealing ring. Alternatively, the gasket can be integral to the cap or to the connector. In a preferred embodiment, the gasket is a separable component that rests on the connector gasket seating.

The gasket is preferably compressible and fluid resistant. Suitable compressible materials include, but are not limited to: silicone, fluorosilicone, nitrile, neoprene, ethylene-propylene-diene-methylene (EPDM), natural or synthetic rubber, polyurethane, and FDA-grade materials. The material should be non-reactive to the fluids and biological material contained within the microfluidic well. The gasket material should also maintain structural integrity at the temperatures intended during operation. The gasket can be reusable or disposable.

The gasket (when viewed from the top or bottom face) can be any two-dimensional shape, such as rectangle, square, circle, or oblong. The perimeter of the gasket is preferably circular, especially when used with a cylindrical connector and cap.

The gasket includes a gasket aperture that provides access to the interior of the microfluidic well. In one embodiment, the gasket aperture does not have a circular perimeter, e.g., it is not concentric to a circular gasket outer perimeter. In a preferred embodiment, the perimeter of the gasket aperture is irregular, more preferably asymmetrical. The center of the gasket aperture can be, but need not be located at the center of the gasket. The center of the gasket aperture is preferably, but not required to be aligned with the center of the microfluidic well.

In another embodiment, the gasket is irregular (e.g., not circular), but symmetrical. More specifically, the indent(s) and protrusion(s) are mirrored laterally across the face of the gasket. In one embodiment, the gasket comprises two indents, one protrusion, and optionally, two alignment holes, such that the gasket is symmetrical across a line of symmetry bisecting the protrusion. This embodiment advantageously permits the gasket to be inserted in either direction (e.g., face-up or face-down) with identical results.

The gasket comprises at least one venting indent and at least one sealing protrusion. The venting indent is an area (recess space) of the gasket aperture that permits gas exchange between the microfluidic well and the lid venting aperture. The sealing protrusion is an area of the gasket body that obstructs gas exchange between the microfluidic well and the lid venting aperture. The venting indent and sealing protrusion are preferably adjacent to one another.

The indent and protrusion preferably extend laterally away and towards the center of the gasket aperture, respectively. Alternatively, the indent and protrusion preferably extend away and towards the microfluidic well opening, respectively, as the center of the gasket and/or the center of the gasket aperture can, but need not align directly above the center of the microfluidic well. In other words, the venting indent expands the area available for gas exchange, and the sealing protrusion narrows the area available for gas exchange.

The indent and protrusion are preferably both curves in the gasket aperture perimeter, although other shapes, such as linear or angular shapes could be used. The gasket aperture can be circular with a single lateral extension outward. Oppositely, the gasket aperture can be circular with a single lateral contraction inward. In a preferred embodiment, the gasket aperture includes both a lateral expansion and a lateral contraction from the perimeter.

The venting indent increases the area of gas exchange. The venting indent provides gas exchange between the interior of the microfluidic well and the exterior of the microfluidic well when the venting indent is positioned below the venting aperture of the lid to define an open configuration of the assembly. In other words, when the cap is placed in the open configuration, gas can be released from the microfluidic well, through the gasket aperture via the venting indent, and through the lid venting aperture to the exterior environment.

The sealing protrusion decreases the area available for gas exchange. The sealing protrusion obstructs gas exchange between the interior of the microfluidic well and the exterior of the microfluidic well when the sealing projection is positioned below the venting aperture of the lid to define a closed configuration. In other words, after the cap has transitioned to the closed configuration, gas is confined to the microfluidic well because the lid venting aperture is sealed by the gasket sealing protrusion.

d. Slope

In some embodiments, the closure assembly further comprises a slope. The slope is an area of increased thickness to increase the tension between the lid and the gasket as the assembly transitions from the open configuration to the closed configuration. The slope can decrease frictional resistance across the gasket sealing protrusion and prevent tearing, turning, or displacement of the gasket during use. In essence, the slope allows the lid to more easily slide over the upper edge of the gasket sealing protrusion.

In one embodiment, the slope projects towards the gasket from the underside of the lid. Preferably, the slope increases in thickness approaching the venting aperture. The lid slope is preferably made of the same material as the lid, e.g., a rigid plastic.

Additionally or alternatively, the gasket can comprise a slope. A gasket slope can project towards the lid from the topside of the gasket, wherein the slope increases in thickness approaching the sealing protrusion to increase the tension between the lid and the gasket as the assembly transitions from the open configuration to the closed configuration.

The slope can be one-directional following the path of transition to open to closed configurations. Thus, for a rotational closure, the slope can be a curved ramp increasing in thickness towards the venting aperture. The slope can, but need not extend along the entire path of transition from open to closed configuration. In some embodiments, the lid slope extends only as the venting aperture approaches the closed configuration. So for a rotational closure, the closure approach could be the final 5°, 10°, 15°, 20°, 25°, or 30° of rotation. In other embodiments, the slope is indifferent to the angle of approach, such as a circular mound.

e. Block

In some embodiments, the closure assembly further comprises a block. The block extends from the underside of the lid towards the gasket. The block can be integral with or adhered to the lid, or the block can be formed as a divot in an otherwise planar lid surface. The block can be solid or hollow as its main purpose described below is volume displacement. The block preferably sits within the gasket aperture when assembled. The block can, but need not seal tightly against the connector and/or gasket. The block reduces the internal volume of the microfluidic well. While some headspace is required to prevent sample contact with the lid, it is desirable to minimize the headspace to reduce the compressible air bubble volume. By reducing the compressible volume, the block can reduce compression forces against the sample. The shape of the block can be any shape as long as it does not interfere with closure or venting. In one embodiment, the thickness of the block is the same as the thickness of the gasket.

f. Alignment

Particularly in embodiments where the microfluidic substrate, connector, and/or gasket are separately manufactured, the closure assembly can include one or more alignment means. The alignments can be visual (e.g., a line or other visual cue) to signal the operator that the components are in proper position for operation. More preferably, the alignment means is mechanical, such as corresponding alignment pins and alignment holes, which not only provide a visual confirmation that the components are aligned, but also add additional stabilization to ensure components do not shift from proper positioning during operation. The alignment holes can extend partially or entirely through the gasket thickness. In a preferred embodiment, the gasket features two alignment holes which correspond to two alignment pins on the gasket seating.

The closure assembly can also include adhesive to maintain alignment between one or more components of the closure assembly, particularly the connector and gasket components.

### III. Methods of Use

The present invention provides methods of reversibly closing a microfluidic well. The microfluidic well can be pre-loaded with fluid contents before depositing biological material. Initial or additional fluids can be supplied via one or more inlet channels. In a preferred embodiment, a biological sample is added to the microfluidic well via the well opening, e.g., through the well upper perimeter such as by a pipette.

In some embodiments, the connector and/or gasket are positioned on the microfluidic device before loading contents into the well. In another embodiment, the connector and/or gasket are applied to the microfluidic well after loading the well. The cap is preferably placed on the assembly after loading of the well contents. But it is also possible to place the cap in an open or closed configuration before at least some of the contents are delivered to the well. In one embodiment, the microfluidic system is used by 1) delivering fluid to the microfluidic well, 2) depositing biological material to the well, and 3) closing the closure assembly.

a. Open, Transition, and Closed Configurations

To close the microfluidic well, the closure assembly is first assembled in an open configuration. In the open configuration, the connector aperture and gasket aperture are disposed over the microfluidic well, and the cap is positioned such that the lid venting aperture is above the gasket venting indent. In this configuration, an air bubble is maintained at the air-liquid interface within the microfluidic well, and little to no pressure is applied to the air bubble during placement of the cap in the open configuration. Accordingly, little to no pressure is applied to the well contents during initial placement of the cap.

Next, the closure assembly is moved through a transition configuration. In one embodiment, the closure assembly is moved manually by an operator. In another embodiment, the closure assembly is moved by automatic or robotic means and may include the closure of several assemblies at once. In one embodiment, the transition configuration is achieved by applying rotational force. In one embodiment, the transition configuration is achieved by applying downward force. In yet another embodiment, the transition configuration is achieved by applying both downward and rotational forces. In one embodiment, the operator moves the cap through the transitional configuration while avoiding occlusion of the lid venting aperture. In a preferred embodiment, the operator applies downward and rotational force to the upper surface of the cap. Even as the operator's finger may directly or indirectly occlude the lid venting aperture, a venting incision can maintain constant pressure within the microfluidic well. As the closure assembly approaches the closed configuration, a slight increase in force can be applied to overcome the narrowing distance between the gasket and the lid as the assembly moves along a slope toward the lid venting aperture.

After the transition, the closure assembly arrives at a closed configuration in which gas exchange is not permitted between the microfluidic well and the exterior environment. In other words, the closure assembly is sealed in the closed configuration. In the closed configuration, the connector aperture and gasket aperture are disposed over the microfluidic well, and the cap is positioned such that the lid venting aperture is above the gasket sealing protrusion.

It is an object of the invention to maintain the interior pressure of the microfluidic well during placement (open configuration), rotation (transition configuration), and closure (closed configuration) of the closure assemblies. In some embodiments, less than 10, 9, 8, 7, 6, 5, 4, 3, 2, or 1 uL of fluid are ejected from the well while using the closure assembly. In another embodiment, less than 20%, 15%, 10%, 5%, 3%, 2%, or 1% of the sample fluid component volume is ejected during closure. In a preferred embodiment, none of the fluid contents are ejected from the well while using the closure assembly. In another embodiment, the pressure within the microfluidic well increases by less than 20 mbar during use of the closure assembly.

In certain embodiments, the connector, gasket, lid, and/or cap do not contact the fluid contents of the microfluidic well in any of the open, transition, or closed configurations. In preferred embodiments, the entire closure assembly does not contact the fluid contents of the well. In this way, the sample is not contaminated, disrupted, or disturbed. Although the closure assembly, particularly the lid, does not contact the sample, it is preferably to sterilize or dispose closure assembly components between each use.

Optionally, the closure process can be reversed by moving the assembly from the closed configuration, through the transition configuration, and back to the open configuration. The cap can then be removed to access the sample in the microfluidic well, e.g., to retrieve the biological material. In a preferred embodiment, the closure assembly can be returned to the open configuration simply by reversing the direction of rotational force and lifting the cap after it returns to the open configuration.

### EXAMPLES

### Example 1: a Microfluidic System with Closure Assembly

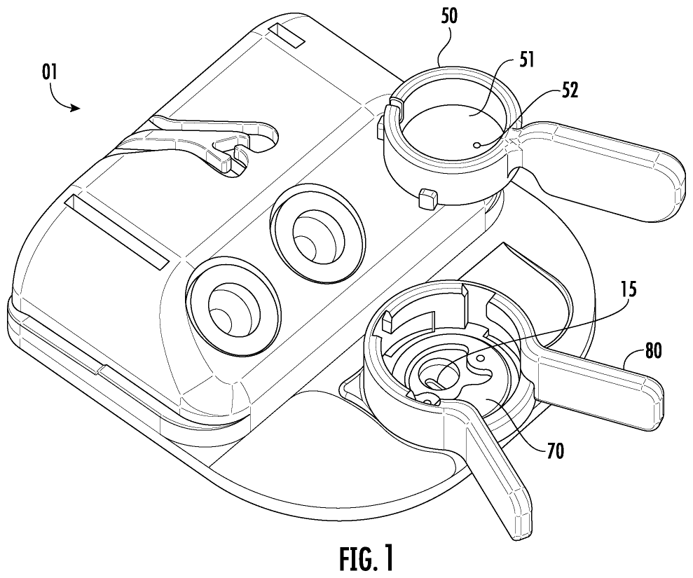

FIG. 1 shows a microfluidic system with an exemplary closure assembly of the present invention. The microfluidic system 01 includes a microfluidic well 15, a connector 80 positioned above the well, and a gasket 70 positioned above connector 80. In FIG. 1, the cap 50 is shown in a detached alignment before engagement with the connector 80. The exploded view shows the cap 50 directly above the open configuration; that is, the cap 50 can descend from this view into engagement with the connector 80 in an open configuration. The cap 50 includes a lid 51 and venting aperture 52. The closure assembly includes the cap 50, gasket 70, and connector 80. Thus, FIG. 1 depicts how the system components would appear to an operator before cap placement.

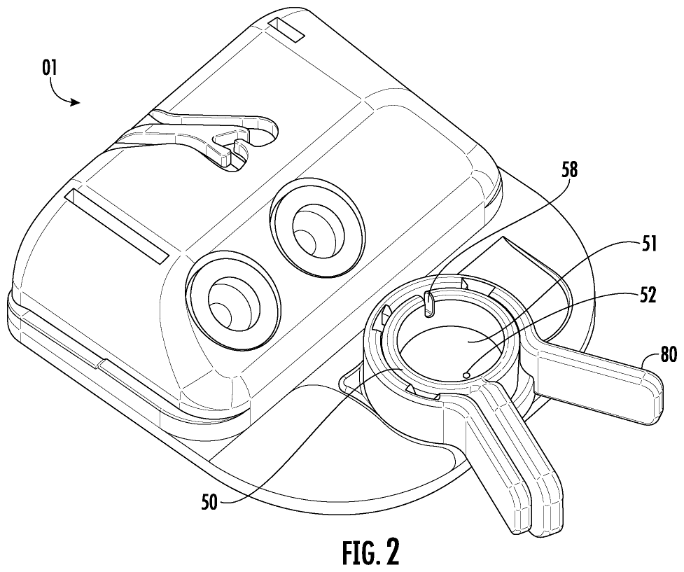

FIG. 2 shows the same microfluidic system 01 in a closed configuration. In this view, the cap 50 is engaged with the connector 80, and the cap 50 has been rotated to the closed configuration. Both the lid 51 and venting aperture 52 are sealed against the gasket (not shown). Thus, FIG. 2 depicts how the system would appear to an operator in the closed configuration.

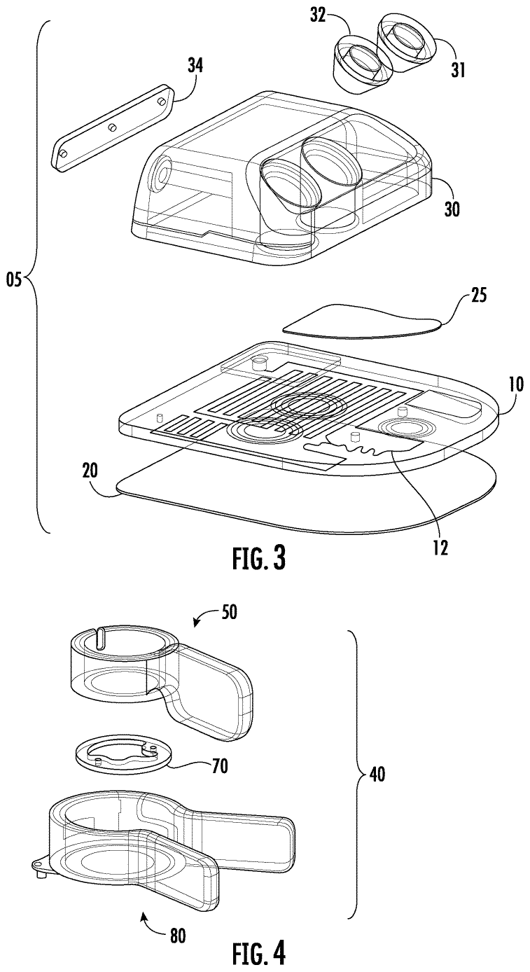

FIG. 3 shows an exploded view of a microfluidic device that can be used with the closure assemblies of the present invention. The separately manufactured components of the exemplary microfluidic device include a bottom layer 20 sealed to a microfluidic layer 10 (which comprises well(s) 15 and channel(s) 12). An adhesive shield 25 blocks light for use with an optional IR (infrared) sensor. The channels are connected to reservoirs which are accessed and sealed by removeable reservoir tops 31, 32. A pressure inlets sealing 34 is used to seal and deliver pressure to fluid contents for delivery via channels. The cover 30 shelters the reservoir and/or channel components.

### Example 2: Closure Assembly Components

FIG. 4 shows an exemplary closure assembly of the present invention. The closure assembly 40 includes a cap 50, a gasket 70, and a connector 80. In this embodiment, each component is separately manufactured, then placed sequentially above the microfluidic layer 10 shown in FIG. 3 for use with a microfluidic device 05.

The connector 80 includes first and second lateral projections, and the cap includes a third lateral projection. When in use, the first and third lateral projections will be aligned in the open configuration. The second and third projections will be aligned in the closed configuration. The lateral projections in FIG. 4 are paddle-shaped and are essentially the same height as the cap and connector, respectively. In this case, alignment of the projections means contacting the paddle surfaces together.

### Example 3: Cap

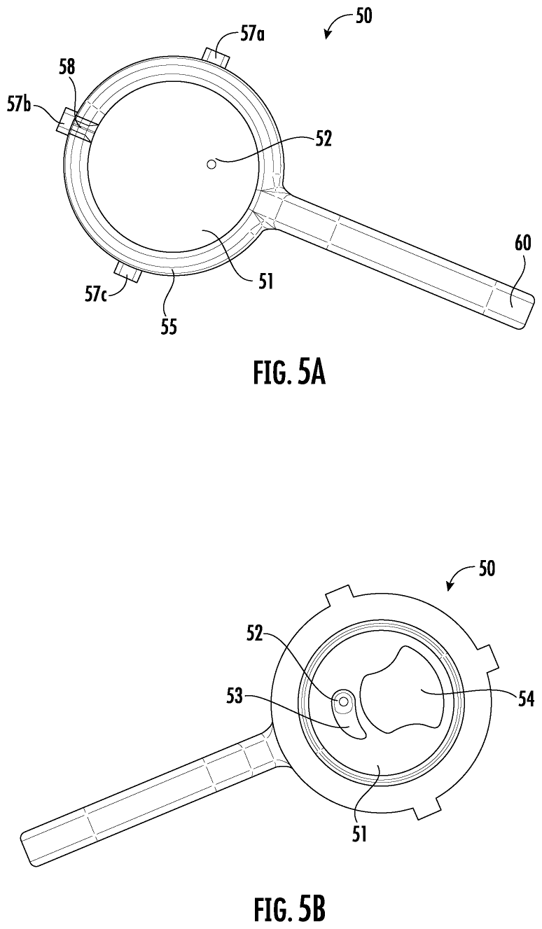

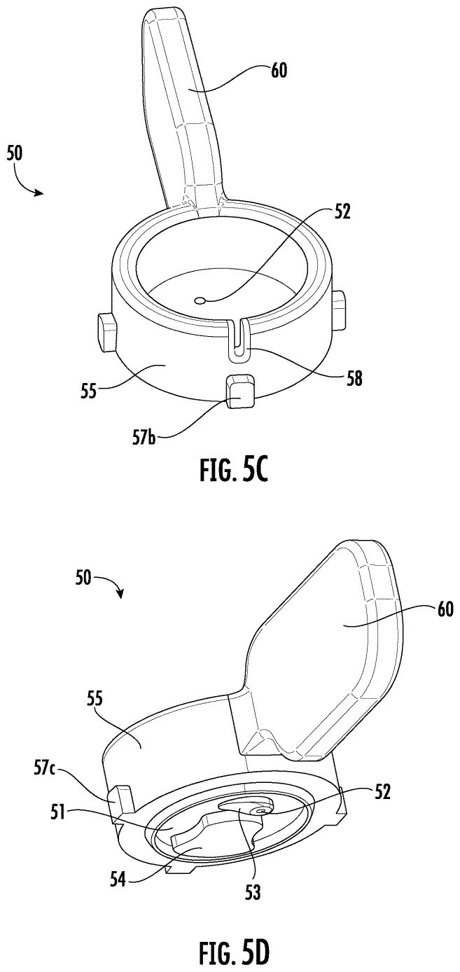

FIGS. 5A and 5B show a top and bottom view, respectively, of an exemplary cap of the present invention. FIG. 5A, top view, shows a cap 50 with a circular lid 51 with an off-center venting aperture 52 therethrough. The venting aperture is on the same side of the lid as a lateral projection 60. On the exterior base of the cap sidewall 55 is a joinder for mating with connector. In this embodiment, the joinder comprises three interlocking tabs 57a-c equidistantly spaced apart, across from the lateral projection 60. The interlocking tabs 57a-c mate with interlocking grooves on a connector (not shown). And the lateral projection 60 aligns with a first and second lateral projection on the connector (not shown). The cap also features a venting incision 58 on the top surface of the cap, opposite the lateral projection 60.

On the underside of the cap shown in FIG. 5B, the cap 50 features a slope 53, which in this embodiment is a curved ramp approaching the venting aperture 52. The underside of cap 50 also includes a block 54, which fits within gasket aperture (not shown) to reduce volume of the microfluidic well (not shown).

FIG. 5C is a perspective view of the topside of the cap 50. This view shows a venting incision 58 as a vertical slit in the cap sidewall 55. In this embodiment, the venting incision 58 is directly above interlocking tab 57b and across from the lateral projection 60. But the venting incision can be placed at any point along the upper perimeter without regard to the location of the joinder mechanism or the lateral projection.

FIG. 5D is a perspective view of the underside of the cap. This view shows the increasing thickness of the slope 53 in its approach to venting aperture 52. This cap features a paddle-shaped lateral projection 60 having approximately the same height as the cap sidewall 55. The exterior of cap sidewall 55 features three interlocking tabs 57 at the base of the cap sidewall 55, while the lid 51 is disposed at the interior base of cap sidewall 55. In this embodiment, the base perimeter of cap sidewall 55 will abut the cap seating of the connector (not shown), while the block 54 will fit within the gasket aperture (not shown) when assembled. While the block 54 and slope 53 will contact the gasket in the closed configuration, the lid does not directly contact the gasket or connector.

### Example 4: Gasket

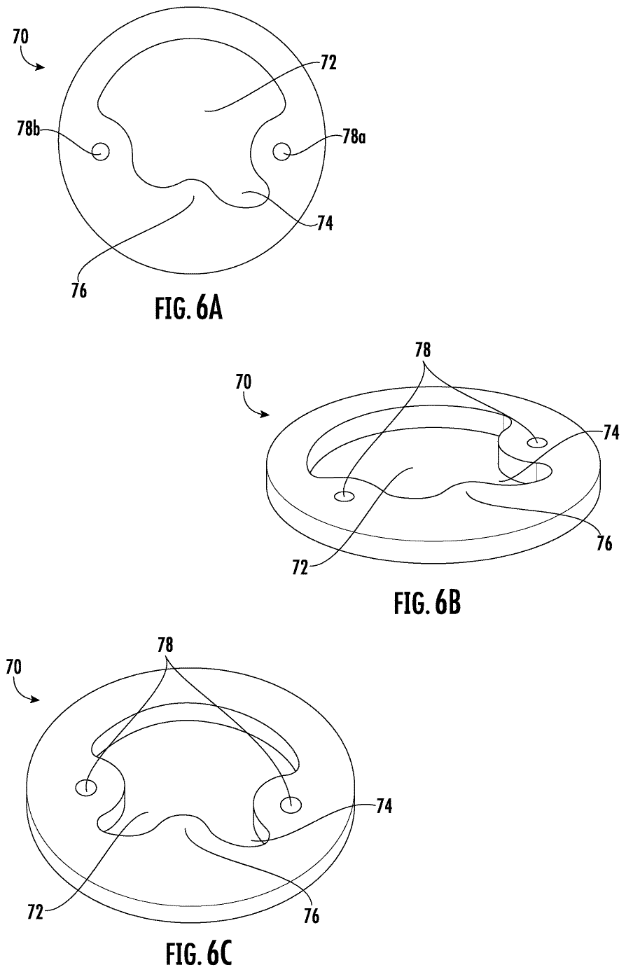

FIG. 6A shows a top view of an exemplary gasket of the present invention. The gasket 70 features a circular outer perimeter (2D shape) and a gasket aperture 72 having an irregular, asymmetrical interior perimeter. When assembled, the microfluidic well (not shown) will be preferably disposed at or near the center of the gasket aperture 72, which is not at the center of the circular gasket 70 as a whole. FIG. 6A features a curved gasket venting indent 74 that extends towards the gasket outer perimeter and a curved gasket sealing protrusion 76 that extends away from the gasket outer perimeter. The gasket aperture 72 also features a concentric portion that mirrors the curvature of the gasket outer perimeter. This concentric portion preferably interfaces with a corresponding concentric portion of the cap block to permit smooth rotation of the cap block within the gasket aperture. Two alignment holes 78a and 78b extend through the gasket 70 to mate with alignment pins on the connector (not shown).

FIG. 6B shows a perspective view of the same gasket 70 as in FIG. 6A. This view shows an embodiment where the gasket outer perimeter and the gasket aperture perimeter both extend parallel to one another and to the gasket center axis, but curved, beveled, or angled edges could be employed for either surface or a portion thereof.

FIG. 6C shows a perspective view of a different, symmetrical gasket 70. This gasket 70 similarly features two venting indents 74, one sealing protrusion 76, and two alignment holes 78. This symmetrical gasket can be placed onto the device in either a face-up or face-down configuration and/or allow closure in two directions of rotation.

### Example 5: Connector

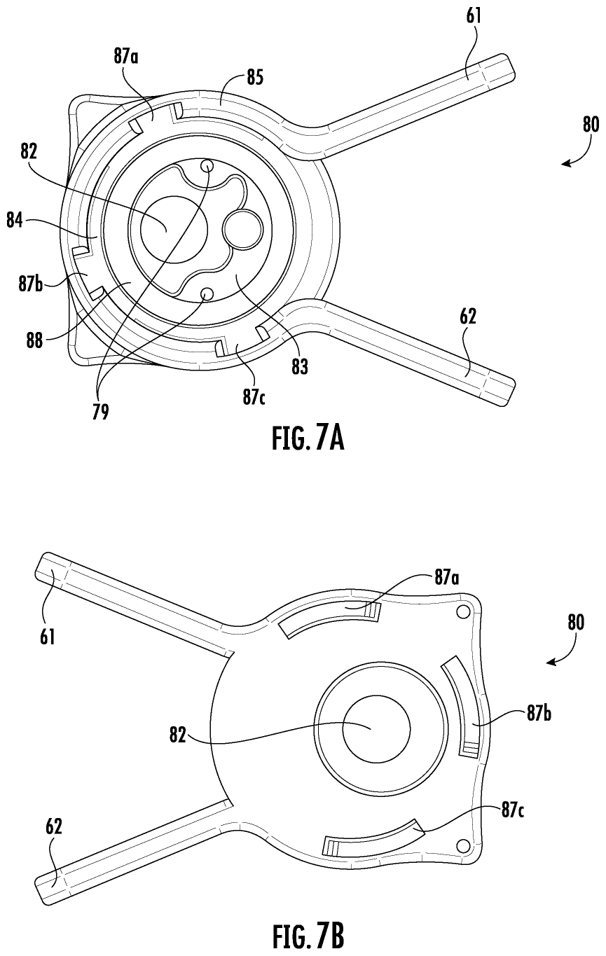

FIGS. 7A and 7B show a top and bottom view, respectively, of an exemplary separate connector of the present invention. This connector embodiment is separately manufactured and sits atop the microfluidic layer when assembled. The connector aperture 82 is disposed over the microfluidic well when assembled. The connector aperture 82 extends through the connector 80 to provide access from above to the microfluidic well. In the top view FIG. 7A, inner platforms are shown to support the gasket (gasket seating 83) and the cap (cap seating 84). A lid recess 88 allows the connector to receive the lid with clearance for rotation.

In this case, the joinder mechanism is achieved by three interlocking grooves 87a-c, each groove having a vertical portion visible in the top view FIG. 7A and a horizontal portion visible in the bottom view FIG. 7B.

The first and second lateral projections 61, 62 extend away from the connector aperture 82 and can extend beyond the surface of the microfluidic layer as shown in FIG. 1. In this embodiment, the first and second lateral projections 61, 62 are approximately the same height and thickness as the connector sidewall 85.

### Example 6: Methods of Closure: Open, Transition, and Closed Configurations

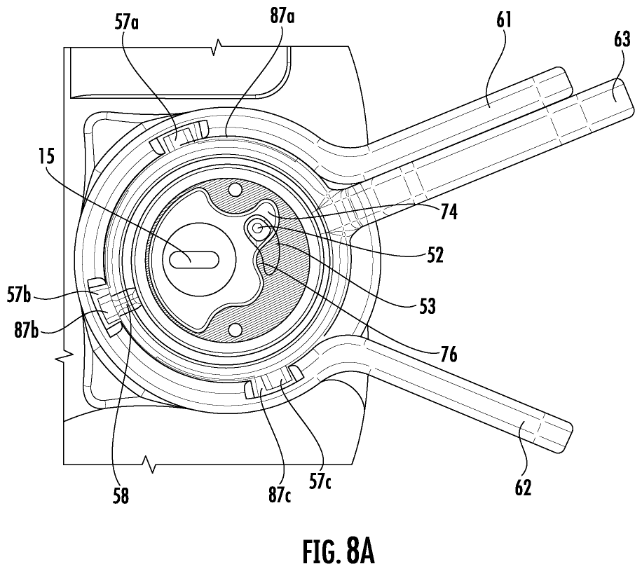

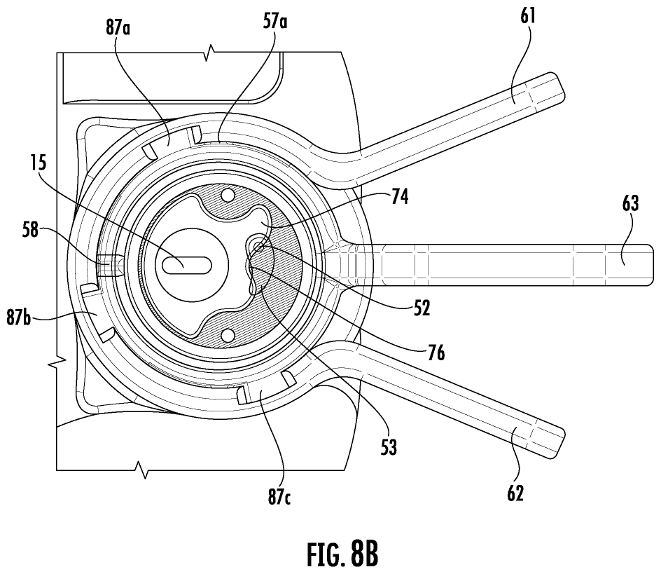

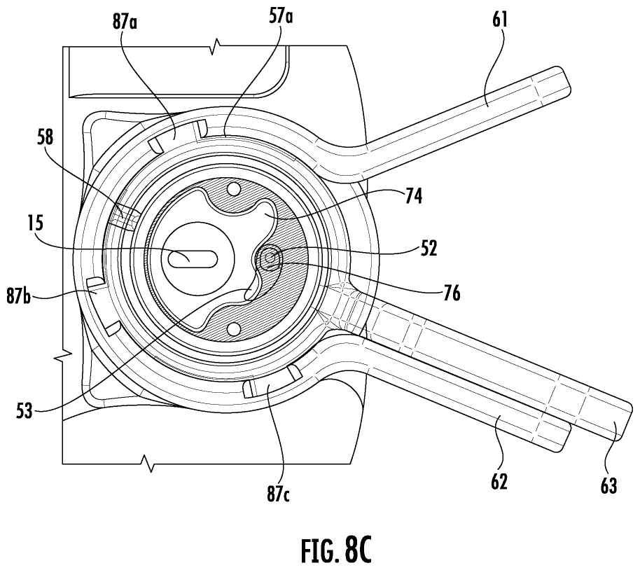

FIG. 8A-C shows the interior mechanics during the operation of an exemplary closure assembly of the present invention.

FIG. 8A shows the closure assembly in the open configuration. The microfluidic well 15 is aligned with both the connector aperture and the gasket aperture and can be seen through the transparent lid. The lid venting aperture 52 is above the gasket venting indent 74 so that gas exchange is permissible from the microfluidic well 15, through the connector aperture, gasket aperture/venting indent, and out through the lid venting aperture 52. The cap interlocking tabs 57a-c are inserted into the vertical portions of connector interlocking grooves 87a-c. The cap third lateral projection 63 is aligned with, that is, directly adjacent to/abutting the connector first lateral projection 61.

FIG. 8B shows the closure assembly in the transition configuration. The stationary microfluidic well 15 remains aligned with the stationary connector and stationary gasket. The cap is rotated such that the venting aperture 52 moves away from venting indent 74 and towards gasket sealing protrusion 76 as slope 53 slides over gasket sealing protrusion 76. The slope 53 facilitates a smooth transition over the upper edge and surface of the gasket. As the cap is rotated, the cap interlocking tabs 57 rotate within the horizontal portion of the connector interlocking grooves 87 to lock the cap in place over the well 15. The cap third lateral projection 63 moves away from the connector first lateral projection 61 and towards the connector second lateral projection 62.

In FIG. 8B, venting aperture 52 is partially occluded as it transitions from its location over the venting indent 74 to over the sealing protrusion 76. Cap rotation is shown halfway from the open to closed configuration, but the transition configuration is meant to encompass any position between open (cap inserted) and closed (cap locked or fully closed) configurations. Thus, the transition configuration encompasses positions where the venting aperture is still vented (partial rotation while venting aperture is over the venting indent), partially occluded (venting aperture straddles venting indent and sealing protrusion), and sealed (partial rotation while venting aperture is over sealing protrusion).

FIG. 8C shows the closure assembly in the closed configuration. The stationary microfluidic well 15 remains aligned with both the stationary connector aperture and the stationary gasket aperture as can be seen through the transparent lid. The lid venting aperture 52 is now above the gasket sealing protrusion 76 so that gas exchange is occluded. Cap rotation is complete when the third lateral projection 63 meets the connector second lateral projection 62 and/or when the cap interlocking tabs reach the horizontal end of the connector interlocking grooves 87. The cap third lateral projection 63 is aligned with, that is, directly adjacent to/abutting the connector second lateral projection 62.

Cap removal can be achieved simply by reversing the rotation and lifting the cap out of the connector.

Although the foregoing invention has been described in some detail by way of illustration and example for purposes of clarity of understanding, one of skill in the art will appreciate that certain changes and modifications may be practiced within the scope of the appended claims. Although particular features have been described herein with respect to certain embodiments, such features may be applied to any embodiment of the present invention.

The article “a” or “an” as used herein means “one or more” when following the open-ended transition “comprising.” Singular or limited number components will be identified as “a single,” “a singular,” or specify the number of units to convey exclusion of additional units.

Each reference provided herein is incorporated by reference in its entirety to the same extent as if each reference was individually incorporated by reference.

What is claimed is:

1. A closure assembly for a microfluidic well comprising:
a. a cap comprising:
i. a lid dimensioned to seal a microfluidic well;
ii. a venting aperture disposed through the lid to provide gas exchange between the interior of the microfluidic well and the exterior of the microfluidic well; and
iii. a joinder that mates the cap to a connector, wherein
b. the connector comprises:
i. a joinder that mates the connector to the cap;
ii. a connector aperture that provides access to the interior of the microfluidic well; and
c. a gasket comprising:
i. a gasket aperture that provides access to the interior of the microfluidic well;
ii. a venting indent that provides gas exchange between the interior of the microfluidic well and the exterior of the microfluidic well when the venting aperture of the lid is positioned above the venting indent of the gasket to define an open configuration; and
iii. a sealing protrusion that obstructs gas exchange between the interior of the microfluidic well and the exterior of the microfluidic well when the venting aperture of the lid is positioned above the sealing protrusion of the gasket to define a closed configuration.

2. The closure assembly of claim 1, further comprising a slope projecting from the lid towards the gasket, wherein the slope increases in thickness approaching the venting aperture to increase the tension between the lid and the gasket as the assembly transitions from the open configuration to the closed configuration.

3. The closure assembly of claim 1, further comprising a block projecting from the lid, wherein the block fits within the gasket aperture.

4. The closure assembly of claim 1, wherein the cap further comprises a venting incision.

5. The closure assembly of claim 1, wherein the joinders are screw threads.

6. The closure assembly of claim 1, wherein the joinders comprise at least one interlocking groove and tab.

7. The closure assembly of claim 6, wherein the cap further comprises at least one interlocking tab, and the connector comprises at least one interlocking groove.

8. The closure assembly of claim 1, wherein the connector further comprises a cap seating that supports the cap.

9. The closure assembly of claim 1, wherein the connector further comprises a recess to receive the lid.

10. The closure assembly of claim 1, wherein the connector further comprises a gasket seating that supports the gasket.

11. The closure assembly of claim 1, wherein the gasket is compressible.

12. The closure assembly of claim 1, wherein the gasket is asymmetrical.

13. The closure assembly of claim 1, wherein the gasket is symmetrical.

14. The closure assembly of claim 1, wherein the closure assembly transitions from the open configuration to the closed configuration by rotating the cap 90° or less.

15. The closure assembly of claim 1, wherein the closure assembly transitions from the open configuration to the closed configuration by applying pressure along an upper surface of the cap.

16. The closure assembly of claim 1, wherein the closure assembly maintains an interior pressure of the microfluidic well when the cap transitions from the open configuration to the closed configuration.

17. The closure assembly of claim 1, wherein the connector comprises first and second lateral projections, and the cap comprises a third lateral projection, wherein the third lateral projection aligns with the first lateral projection in the open configuration, and the third lateral projection aligns with the second lateral projection in a closed configuration.

18. The closure assembly of claim 1, further comprising at least one alignment means between the connector and a microfluidic layer and/or the connector and the gasket.

19. The closure assembly of claim 18, wherein at least one of the alignment means comprises a seating pin.

20. The closure assembly of claim 19, wherein the gasket comprises one or more seating holes, and the connector comprises one or more seating pins.

21. The closure assembly of claim 1, wherein the connector does not contact a fluid contents of the microfluidic well.

22. The closure assembly of claim 1, wherein the cap does not contact a fluid contents of the microfluidic well in the open or closed configuration.

23. The closure assembly of claim 1, wherein at least a portion of the lid is transparent.

24. A microfluidic system comprising:
a. a closure assembly according to claim 1;
b. a microfluidic layer comprising at least one microfluidic well connected to at least one microfluidic channel.

25. The microfluidic system of claim 24, wherein the connector is integral with the microfluidic layer.

26. The microfluidic system of claim 24, wherein a sample volume in the microfluidic well is 50 uL or less.

27. A method of closing a microfluidic well comprising:
a. providing a closure assembly according to claim 1;
b. placing the closure assembly over a microfluidic well in the open configuration; and
c. transitioning the closure assembly from the open configuration to the closed configuration by rotating the cap 90° or less.

28. The method of claim 27, wherein transitioning further comprises applying pressure along an upper surface of the cap across a venting incision.
